(19) United States
(12) Patent Application Publication
(10) Pub. No.: US 2008/0310388 A1
(43) Pub. Date: Dec. 18, 2008

(54) TRANSMISSION OF RADIO BLOCKS IN REDUCED TRANSMISSION TIME INTERVAL MODE

(75) Inventors: Behrouz Aghili, Melville, NY (US); Marian Rudolf, Montreal (CA); Stephen G. Dick, Nesconset, NY (US); Prabhakar R. Chitrapu, Blue Bell, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/137,735

(22) Filed: Jun. 12, 2008

Related U.S. Application Data
(60) Provisional application No. 60/943,391, filed on Jun. 12, 2007.
(60) Provisional application No. 60/985,818, filed on Nov. 6, 2007.

(51) Int. Cl. H04J 3/00

(52) U.S. Cl. 370/345

(57) ABSTRACT

A method and apparatus for operating a wireless transmit receive unit (WTRU) in basic transmission time interval (BTTI) and reduced transmission time interval (RTTI) mode includes a WTRU in RTTI mode and a WTRU in BTTI mode receiving a plurality of coded radio blocks, the WTRU in RTTI mode decoding all of the plurality of coded radio blocks and the WTRU is in BTTI mode decoding a portion of the plurality of coded radio blocks.

### CROSS REFERENCE TO RELATED APPLICATIONS

This application claims the benefit of U.S. provisional applications Nos. 60,943,391, filed Jun. 12, 2007, and 60, 985, 818 filed Nov. 6, 2007 which are incorporated by reference as if fully set forth.

### FIELD OF INVENTION

The present invention is related to wireless communication systems.

### BACKGROUND

A goal of the Third Generation Partnership Project (3GPP) Evolution program is to develop new technology, new architecture and new methods for settings and configurations in wireless communication systems in order to improve spectral efficiency, reduce latency and better utilize the radio resource to bring faster user experiences and richer applications and services to users with lower costs.

Release 7 (R7) of the 3GPP global system for mobile communications (GSM) introduces several features that may improve upon throughput and reduce latency of transmissions in the uplink (UL) and downlink (DL). UL improvements are referred to as higher uplink performance for GERAN evolution (HUGE) and downlink improvements are referred to as reduced symbol duration higher order modulation and turbo coding (REDHOT). Both are included in the evolved general packet radio system (EGPRS)-2 project.

EGPRS-2 includes two (2) technical approaches that can operate stand-alone or in conjunction with any of the other GSM R7 improvements. One approach is the Fast Acknowledge/Negative-Acknowledge (ACK/NACK) Reporting (FANR) feature. A second approach is a Reduced Transmission Time Interval (RTTI) feature. A wireless transmit receive unit (WTRU) can operate in both FANR and RTTI modes of operation with legacy EGPRS modulation-and-coding schemes (MCSs) and with the newer EGPRS-2 modulation and coding schemes, such as REDHOT or HUGE. FANR or RTTI operation can also be combined with GSM R7 Downlink Dual-Carrier mode of operation (DARP Phase I or II) as well as future modes of GSM operation in which the Temporary Block Flow (TBF) of a WTRU packet connection is set up to operate using FANR or RTTI transmission or reception.

Prior to GSM R7, legacy EGPRS permitted transmission only in a basic transmission time interval (BTTI) format. BTTI transmission requires the transmission of four (4) bursts per radio block. Each burst is sent on the same assigned timeslot per frame over four (4) consecutive frames. For example, if a WTRU is assigned timeslot (TS) 3, it may receive an entire radio block by extracting a first burst from TS 3 in GSM frame (N), a second burst from TS 3 in GSM frame (N+1), third burst from TS 3 in GSM frame (N+2), and a fourth burst from TS 3 in GSM frame (N+4), where N is an integer value. As each frame has duration of 4.615 msec, pursuant to the GSM standard. The transmission of an entire radio block takes four (4) frames times 4.615 msecs, or approximately 20 msecs. It is also possible that a WTRU is assigned more than one (1) TS for reception of data by using multislot transmission and/or reception capabilities. Therefore, any of the assigned timeslots may contain a separate radio block received over a duration of 20 msecs. The exact time that a radio block can start, that is, the location of the GSM frame that contains the first burst, is given by frame timing rules in the GSM standard.

GSM R7 also may include using an RTTI transmission format, where a pair of timeslots in a first GSM frame contains a first set of two (2) bursts, and second GSM frame contains a second set of two (2) bursts. The first and second frames of the four (4) total bursts make up the radio block. A transmission using RTTI therefore only takes 2 frames times 4.615 msecs, or roughly 10 msecs. RTTI operation is possible with both EGPRS and EGPRS-2 transmission formats.

Multiple WTRUs may be sharing the same uplink (UL) and/or downlink (DL) resources. This may be accomplished by multiplexing the DL signals for the multiple WTRUs on the single physical resource, such as the Packet Data Channel (PDCH), for example.

A WTRU, such as a legacy WTRU, for example, can operate in BTTI-mode only. Alternatively, a WTRU can support RTTI-mode only. The GSM R7 standard includes a number of possibilities to assign WTRUs to timeslots in conjunction with BTTI and/or RTTI operation. In a first mode of operation, one or more timeslots are exclusively assigned to WTRUs with TBFs operating in BTTI-mode only. In a second mode of operation, one or more timeslots are exclusively assigned to WTRUs with TBFs operating in RTTI mode only. In a third mode of operation, one or more timeslots are assigned to WTRUs with one or more TBFs operating in BTTI mode simultaneously with one or more TBFs on the same timeslots operating in RTTI mode.

Constraints arise when WTRUs that are not RTTI compatible are multiplexed with WTRUs that are using RTTI. For example, transmissions to WTRUs that are assigned one or more TBFs using the RTTI format may be multiplexed onto shared timeslots with BTTI WTRU. The RTTI WTRUs must respect the legacy uplink state flag (USF) format and corresponding stealing flag (SF) settings of legacy BTTI WTRUs.

Also, legacy burst processing techniques may create a problem. A legacy BTTI WTRU may determine the modulation type of a received radio block by processing the radio block with appropriate phase rotations and burst detection techniques before attempting to process the SF, the USF, and the radio link control/medium access control (RLC/MAC) header information. Therefore, two consecutive RTTI radio blocks that may be sent to a legacy WTRU during one legacy BTTI time interval should include the same modulation type in each radio block, in order not to impact USF decoding ability by the legacy BTTI WTRU. For example, both radio blocks may be GMSK, or both radio blocks may be 8PSK, but they should not be mixed.

Also, a BTTI WTRU may assume that any BTTI radio block on its assigned timeslots and transmitted over a period of four (4) consecutive GSM frames can only start at certain, well-defined instances, for example, in frame (N), (N+4) or (N+8), where N is an integer value. Therefore, if an RTTI block is transmitted to an RTTI WTRU in frames N and (N+1), for example, a BTTI radio block to a second WTRU can not be transmitted starting in frame (N+2).

It has been a working assumption that if a first RTTI block is transmitted in the first 10 ms of a 20 ms time BTTI interval, then a second RTTI block will follow. This will occur when the BTTI/RTTI signals are multiplexed or non-multiplexed because legacy WTRUs assume that transmission of radio blocks is on a 20 ms TTI basis.

It has also been a working assumption that when operating using RTTI USF and BTTI USF, control blocks for a WTRU assigned to operate in RTTI mode should be sent in 10 ms intervals. However there are no working assumptions on how a base station system (BSS) should handle the second 10 ms interval, especially if there are no more RTTI radio blocks scheduled to be sent.

Another issue arising out BTTI/RTTI mode of operation in GSM R7 is that any WTRU monitoring its assigned packet resources, that is, timeslots, should successfully decode some number of radio blocks occurring over a certain time period to avoid declaring radio failure. Radio failure may result in the release or an interruption of packet reception. However, currently there are no working assumptions regarding techniques to ensure that WTRUs assigned either BTTI or RTTI TBFs are guaranteed a successful decoding opportunity, particularly in the case of mixed RTTI/BTTI operation on the same timeslot.

BTTI radio blocks are coded using a robust coding scheme, typically CS-1. However, when BTTI and RTTI WTRUs are multiplexed on a PDCH, CS-1 cannot be used. Therefore, it would be desirable to have a new coding scheme for muliplex BTTI and RTTI WTRUs.

### SUMMARY

A method and apparatus are disclosed for operating WTRUs in BTTI mode and RTTI mode. A BSS may transmit control and/or data blocks in the second 10 ms time interval for reception by a WTRU operating in RTTI mode. The BSS may also temporarily operate in BTTI mode in order to use CS-1 coding.

### BRIEF DESCRIPTION OF THE DRAWINGS

A more detailed understanding may be had from the following description, given by way of example and to be understood in conjunction with the accompanying drawings wherein:

FIG. 1 shows an example wireless communication system in accordance with one embodiment;

FIG. 2 is a functional block diagram of a WTRU and the base station of FIG. 1;

FIG. 3 shows transmission of two radio blocks in BTTI mode;

FIG. 4 shows transmission of the radio blocks of FIG. 3 in RTTI mode; and

FIG. 5 shows a BTTI radio block and an RTTI radio block multiplexed onto a PDCH.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

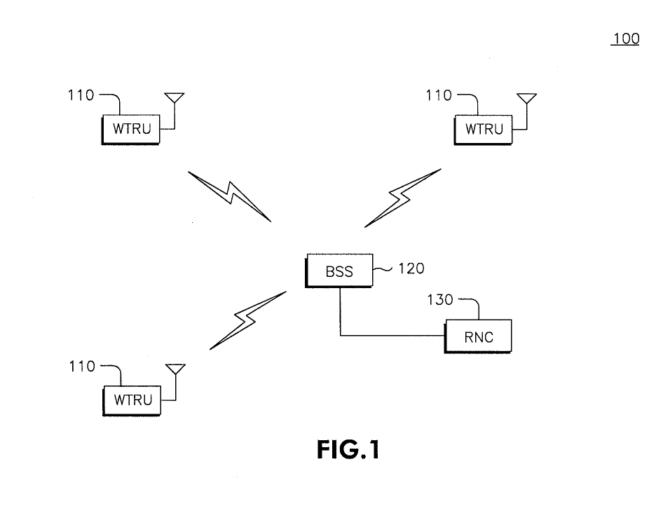

FIG. 1 shows a wireless communication system 100 including a plurality of WTRUs 110, a base station 120, and an RNC 130. As shown in FIG. 1, the WTRUs 110 are in communication with the base station 120, which is in communication with the RNC 130. Although three WTRUs 110, one base station 120, and one RNC 130 are shown in FIG. 1, it should be noted that any combination of wireless and wired devices may be included in the wireless communication system 100.

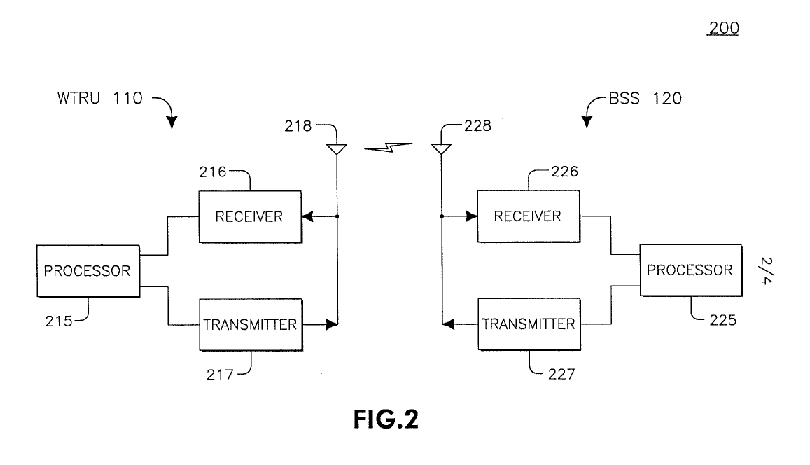

FIG. 2 is a functional block diagram 200 of a WTRU 110 and the base station 120 of the wireless communication system 100 of FIG. 1. As shown in FIG. 1, the WTRU 110 is in communication with the base station 120 and both may be configured to perform in RTTI mode or BTTI mode.

In addition to the components that may be found in a typical WTRU, the WTRU 110 includes a processor 215, a receiver 216, a transmitter 217, and an antenna 218. The processor 215 may be configured to process BTTI and/or RTTI radio blocks. The receiver 216 and the transmitter 217 are in communication with the processor 215. The antenna 218 is in communication with both the receiver 216 and the transmitter 217 to facilitate the transmission and reception of wireless data.

In addition to the components that may be found in a typical base station, the base station 120 includes a processor 225, a receiver 226, a transmitter 227, and an antenna 228. The processor 225 may be configured to process BTTI and/or RTTI radio blocks. The receiver 226 and the transmitter 227 are in communication with the processor 225. The antenna 228 is in communication with both the receiver 226 and the transmitter 227 to facilitate the transmission and reception of wireless data.

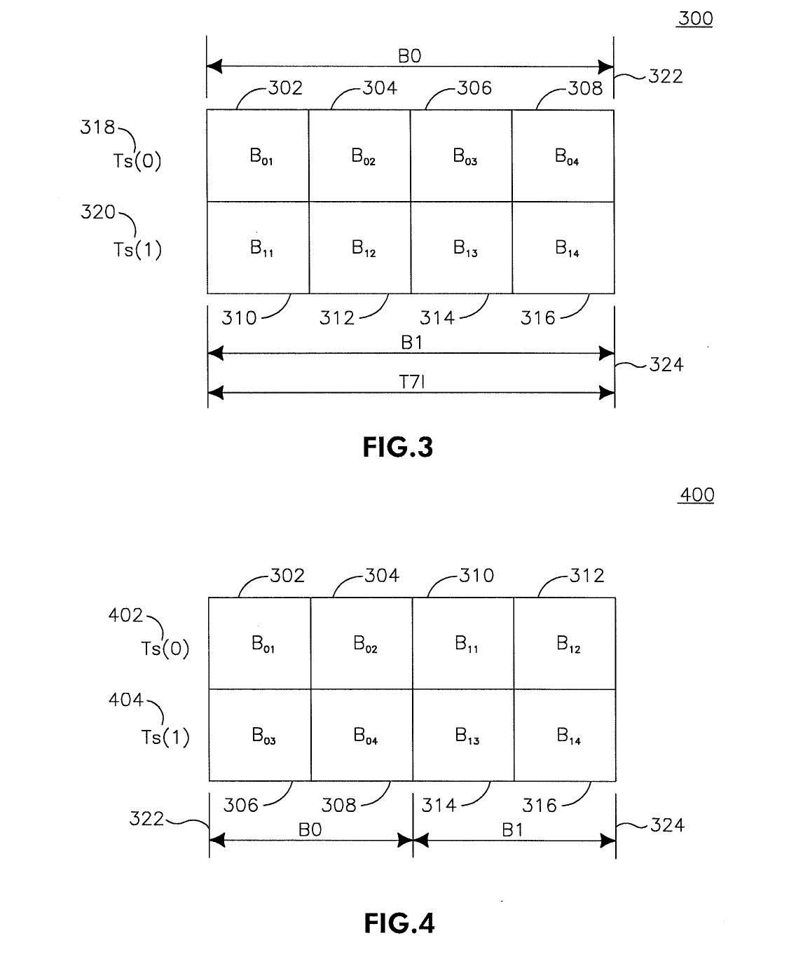

FIG. 3 shows transmission of two radio blocks 300 in BTTI mode. Radio block B0 (322) includes four (4) frames, B₀₁ (302), B₀₂ (304), B₀₃ (306) and B₀₄ (308) that are transmitted in a single timeslot, TS(0) 318, with duration of approximately 20 ms. Radio block B₁ (324) includes four (4) frames, B₁₁ (310), B₁₂ (312), B₁₃ (314) and B₁₄ (316) that are transmitted in a single timeslot, TS(1) 320, also with a duration of approximately 20 ms.

FIG. 4 shows transmission of the radio blocks 300 of FIG. 3 in RTTI mode. Radio block B0 (322) includes frames B₀₁ (302) and B₀₂ (304) that are broadcast in TS(0) 402. B0 (322) also includes frames B₀₃ (306) and B₀₄ (308) that are broadcast in the second timeslot TS(1) 404. Radio block B₁ (324) includes frames B₁₁ (310) and B₁₂ (312) that are transmitted in the first time slot T(0) 402 and frames B₁₃ (314) and B₁₄ (316) that are transmitted in the second time slot T(1) 404. Each radio block can be broadcast in approximately 10 ms.

WTRUs that are operating in BTTI mode are expecting BTTI radio blocks to begin at well-defined frame numbers in 20 ms time intervals. The BSS can not transmit a new radio block in the second consecutive 10 ms time interval over the 20 ms BTTI period as a BTTI WTRU that is configured to receive the radio blocks as shown in FIG. 3 will not properly receive the radio blocks as shown in FIG. 4. However, an RTTI WTRU has the ability to receive twice the amount of information as a BTTI WTRU in the same amount of time. In order to not waste the ability of an RTTI WTRU that is forced to function in a network with BTTI WTRUs, the second 10 ms TTI (radio block B1 324 of FIG. 4) may contain a signal that only RTTI WTRUs may receive, but that BTTI WTRUs do not need to function properly.

In a first embodiment, in the second 10 ms RTTI time interval, a BSS may transmit a copy of the same radio block sent in the first 10 ms RTTI time interval of the 20 ms BTTI period. Referring again to FIG. 4, frames B₁₁ (310) and B₁₂ (312) may be the same as frames B₀₁ (302) and frames B₀₂ (304). The BTTI WTRUs will not miss receiving any new data even though the BTTI WTRUs do not decode the second 10 ms TTI. The retransmission of the RTTI radio block may increase the reliability of decoding in the RTTI WTRU and may increase the link performance and robustness of the first RTTI transmission.

For example, when RLC/MAC control blocks are transmitted to the WTRU, the BSS does not need to wait for an acknowledge/negative acknowledge (ACK/NACK) report from the WTRU before starting a subsequent redundancy transmission. This may reduce transmission latency, because the ACK/NACK loop and resulting retransmission delay does not occur.

Alternatively, the second 10 ms transmission of the RTTI radio block may include the same payload as the first transmission, but it may use a different EGPRS or EGPRS-2 modulation and coding scheme (MCS) and/or puncturing scheme in order to provide a combining opportunity in the WTRU. As the same data is transmitted in two different MCS schemes, there is a better opportunity for the RTTI WTRU to decode the data properly. For example, if turbo coding has been used, the parity bits can be sent in the second transmission, assuming that the systematic bits were transmitted in the fist 10 ms radio block.

Alternatively, the BSS can send a unicast or broadcast type of control message, such as “Packet System Information” for example, in the second 10 ms time interval. This message may be received and processed by more than one WTRU. All WTRUs that are assigned to monitor the PDCH or PDCH pair may receive the message.

USF decoding allows multiple WTRUs to use the same PDCH. To make USF decoding possible for BTTI WTRUs, the BSS can send four (4) dummy bursts, where the coded USF bits are mapped for BTTI transmission.

In another embodiment, the BSS may transmit a preferred or default indication to the WTRU. The preferred or default indication may indicate a preferred or default mode of operation for transmissions in consecutive RTTI intervals. The indication may be valid for a single BTTI interval or may remain valid for a sequence of BTTI intervals.

The duration of the validity of the indication may be signaled to the WTRU through system configuration messages and/or capability indication for the specified mode of operation to at least one WTRU. The BSS may use a message such as a Packet System Information (PSI) message on a Packet Access Control Channel (PACCH), for example, to convey the length of the validity of the preferred or default indication. In particular, the message can be used both to configure desired behavior in DL and/or UL PDCH transmissions, such as decoding dummy burst or duplicating the same radio block over the second RTTI interval.

A field in an RLC/MAC header may indicate to the receiving WTRU that a second RTTI transmission is imminent. The BTTI WTRU will not decode this field, as it may be placed in the second RTTI TTI. However, an RTTI WTRU may require a warning as to the nature of the second RTTI transmission. The same field may be used to indicate that the transmission in the second 10 ms interval may contain control packets or dummy bursts.

For reasons such as queuing and transmission delays, for example, RLC/MAC packets may be buffered in a BSS. A prioritization rule may be imposed on RLC/MAC packets to accommodate the retransmission and/or RTTI/BTTI WTRU coexistence on assigned PDCH resources. For example, RTTI RLC/MAC control clocks may be prioritized over RTTI RLC/MAC data blocks.

A rule may be defined and transmitted to all WTRUs that makes the choice of which block to send in a consecutive RTTI interval dependent on a packet sent in a preceding RTTI interval. For example, if no other RTTI data is available for a second RTTI interval, then control information, a retransmission or a dummy burst may be transmitted. If RTTI data is available, the data may be transmitted prior to the non-data blocks.

An example includes a rule that prioritizes BTTI blocks over RTTI blocks at the beginning of a BTTI period and under certain conditions.

Another example includes a rule may be established that excludes BTTI blocks from being scheduled inside the second RTTI period. This rule may depend on the number of RTTI blocks available in the BTTI period. It may also depend upon the defining of a rule that requires the BSS to fill in BTTI intervals with even numbers of RTTI transmissions.

The priority rule can be fixed or dynamically changed during system operation. The rule may be advertised to a group of WTRUs during operation, or a default rule may be transmitted.

In another embodiment, during RTTI transmission, the BSS may schedule at least one intermittent BTTI transmission in certain predetermined, regular or irregular time intervals on a given resource assigned to the WTRUs. This may decrease the occurrences of a BTTI WTRU declaring radio failure, as a BTTI WTRU may not be able to decode the RTTI block, and may receive an excess number of headers that can not be decoded.

EGPRS supports a number of modes of UL resource allocation, including dynamic allocation, extended dynamic allocation and exclusive allocation, while UL assignments of PDCH resources may be controlled by the network. Further, the network may configure a WTRU to use BTTI USF or RTTI USF for receiving and monitoring USFs in the DL. Due to the coupling of DL and UL resource assignments through the USF, the methods and apparatus disclosed herein may be used in the UL direction as well as the DL direction.

For example, in the UL, a WTRU can transmit, in a second 10 ms interval, a copy of the signal transmitted in the first 10 ms interval. Alternatively, the WTRU may transmit control blocks in the second 10 ms interval.

A WTRU may apply priority rules for RTTI/BTTI usage in order to select the contents of an UL PDCH transmission. The WTRU may prioritize data blocks over control blocks and apply priority rules for the type of signals to be transmitted in the first 10 ms interval versus the second 10 ms interval.

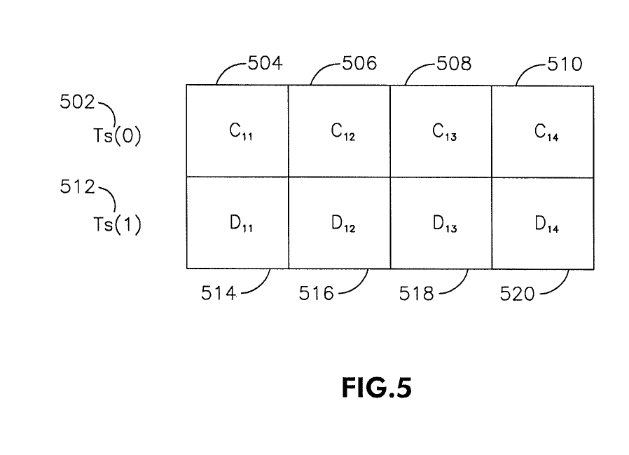

In another embodiment, the BTTI mode of operation may be temporary if it is used for transmission only of control signaling blocks. The network may signal that the BTTI mode is only temporary. FIG. 5 shows a BTTI radio block and an RTTI radio block multiplexed onto a PDCH 500. In a first radio block, a BTTI control block (C1) may be coded according to CS-1 and transmitted on TS(0) 502 of the PDCH 500. The control block is transmitted in four frames, C₁₁ (504), C₁₂ (506), C₁₃ (508) and C₁₄ (510). The CS-1 coding scheme may be indicated by the eight (8) stealing flags (SFs) as 1111-1111 (not shown). Two (2) bits of the 8 SFs are sent per frame. In a second radio block, a data block (D1) is transmitted in the second time slot TS(1) 512.

The second radio block is also transmitted in four (4) frames, D₁₁ (514), D₁₂ (516), D₁₃ (518) and D₁₄ (520).

Each WTRU may perform a blind determination of the TTI mode. If the mode is correctly determined to be BTTI, both RTTI and BTTI WTRUs will correctly attempt to decode the radio block pursuant to CS-1 rules. If a blind determination is correctly performed, D1 can be any radio block, control or data, coded in MCS or CS, because D1 will not be decoded by the BTTI WTRU, only the RTTI WTRU. Therefore, only C1 needs to be coded by CS-1.

Alternatively, TTI mode may also be explicitly signaled using layer-1 (L1) signaling. C1 can be transmitted in CS-1. Referring to FIG. 5, a WTRU operating in RTTI mode will process the first two frames 504,506 in TS(0) 502 and attempt to read the SFs. The WTRU will read 1111, as CS-1 is used to transmit C1 in TS(0) 502.

The RTTI WTRU can be preprogrammed to interpret the stealing flag combination of 1111 as meaning that there are two (2) BTTI transmissions, both sent in CS-1. Therefore, rather than reading the first two frames 504,506 of TS(0) 502 and the first two frames of 514, 516 of TS(1) as a single RTTI radio block, the WTRU knows that these are BTTI frames and can buffer the frame contents. The WTRU can then wait until it receives and processes the next two (2) frames of data, which are C₁₃ (508) and C₁₄ (510) from TS(0) 502 and D₁₃ (518) and D₁₄ (520) from TS(1) 504. The WTRU can then decode C1 and D1.

The stealing flag may be repeated in C1 and D1. This redundancy can be used to improve the detection performance of the stealing flags, by combining the received symbols for the stealing flags in frames 1 and 2 with those of frames 3 and 4.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of operating a wireless transmit receive unit (WTRU), the method comprising:
the WTRU receiving a first radio block in a first time interval, and
the WTRU receiving a second radio block in a second time interval; wherein the WTRU is configured to operate in a reduced transmission time interval (RTTI) mode and the first time interval and the second time interval are reduced transmission time intervals relative to a basic transmission time interval.

2. The method as in claim 1 wherein the first radio block and the second radio block are the same.

3. The method as in claim 1 further comprising decoding the first radio block according to a first modulation and coding scheme (MCS) and decoding the second radio block according to a second MCS.

4. The method as in claim 1 wherein the second radio block includes a control message.

5. The method as in claim 1 further comprising the WTRU:
receiving a plurality of dummy bursts comprising uplink state flag (USF) bits mapped for the basic transmission time interval operation; and
decoding the USF bits.

6. The method as in claim 1 further comprising the WTRU receiving a preferred indication.

7. The method as in claim 6 wherein the preferred indication includes an indication of a preferred mode of RTTI radio block reception.

8. The method as in claim 6 further comprising the WTRU determining a length of preferred mode operation based on a reception of the preferred indication.

9. The method as in claim 1 further comprising the WTRU receiving a medium access control (MAC)/radio link control (RLC) header and determining radio block reception based on the MAC/RLC header.

10. The method as in claim 1 further comprising:
the WTRU transmitting the first radio block in the first time interval; and
the WTRU transmitting the second radio block in the second time interval.

11. The method as in claim 10 further comprising the WTRU transmitting the radio blocks based on a preprogrammed rule.

12. A method to operate a base station (BSS), the method comprising:
transmitting a first radio block to a wireless transmit receive unit (WTRU) in a first time interval; and
transmitting a second radio block to the WTRU in a second time interval; wherein the BSS is configured to operate in a reduced transmission time interval (RTTI) mode and the first time interval and the second time interval are reduced transmission time intervals relative to a basic transmission time interval.

13. The method as in claim 12 wherein the first radio block and the second radio block are the same.

14. The method as in claim 12 further comprising coding the first radio block according to a first modulation and coding scheme (MCS) and coding the second radio block according to a second MCS.

15. The method as in claim 12 wherein the second radio block includes a control message.

16. The method as in claim 12 further comprising the BSS transmitting a plurality of dummy bursts comprising uplink state flag bits mapped for the basic transmission time interval operation.

17. The method as in claim 12 further comprising the BSS transmitting a preferred indication.

18. The method as in claim 17 wherein the preferred indication includes an indication of a preferred mode of RTTI radio block reception.

19. The method as in claim 17 further comprising the BSS transmitting a length of preferred mode operation.

20. The method as in claim 12 further comprising the BSS transmitting a medium access control (MAC)/radio link control (RLC) header including an indication of radio block reception.

21. The method as in claim 12 further comprising:
the BSS buffering a plurality of radio link control (RLC)/medium access control (MAC) packets;
the BSS transmitting the plurality of RLC/MAC packets in RTTI mode or basic transmission time interval (BTTI) mode based on a preprogrammed rule.

22. The method as in claim 21 further comprising the BSS transmitting an RTTI RLC/MAC control clock before transmitting a RTTI RLC/MAC data block.

23. The method as in claim 21 further comprising the BSS transmitting a BTTI radio block prior to an RTTI radio block at a predetermined BTTI time period.

24. The method as in claim 12 further comprising the BSS scheduling a basic transmission time interval (BTTI) transmission in a predetermined time interval.

25. The method as in claim 12 further comprising the BSS transmitting a control radio block in a time limited basic transmission time interval (BTTI) mode.

26. The method as in claim 12 further comprising the BSS:
coding a control radio block;
transmitting the control radio block;
coding a data radio block; and
indicating a radio block coding scheme with a plurality of stealing flags.

27. A method for operating a wireless transmit receive unit (WTRU) in basic transmission time interval (BTTI) and reduced transmission time interval (RTTI) mode, the method comprising:
operating a first WTRU in RTTI mode;
operating a second WTRU in BTTI mode;
the first WTRU and the second WTRU receiving a plurality of coded radio blocks;
the first WTRU decoding all of the plurality of coded radio blocks; and
the second WTRU decoding a portion of the plurality of coded radio blocks.

28. A base station (BSS) comprising:
a transmitter configured to transmit a first radio block to a wireless transmit receive unit (WTRU) in a first time interval and a second radio block to the WTRU in a second time interval, wherein the first time interval and the second time interval are reduced transmission time intervals relative to a basic transmission time interval; and
a processor configured to process data blocks in a reduced transmission time interval (RTTI) mode.

29. The BSS as in claim 28 wherein the first radio block and the second radio block are the same.

30. The BSS as in claim 28 wherein the processor is further configured to code the first radio block according to a first modulation and coding scheme (MCS) and code the second radio block according to a second MCS.

31. The BSS as in claim 28 wherein the second radio block includes a control message.

32. The BSS as in claim 28 wherein the transmitter is further configured to transmit a plurality of dummy bursts comprising uplink state flag (USF) bits mapped for basic transmission time interval operation.

33. The BSS as in claim 28 wherein the transmitter is further configured to transmit a preferred indication.

34. The BSS as in claim 28 wherein the processor is further configured to choose from RTTI mode or BTTI mode based on a preprogrammed rule.

35. The BSS as in claim 28 wherein the processor is configured to limit a time for BTTI mode operation.

36. The BSS as in claim 28 wherein:
the processor is further configured to code a control radio block and a data radio block; and
configure a plurality of stealing flags to indicate a coding scheme; and
the transmitter is further configured to transmit the coded control radio block and data radio block with the plurality of stealing flags.
